(19) United States
(12) Patent Application Publication
(10) Pub. No.: US 2015/0224641 A1
(43) Pub. Date: Aug. 13, 2015

(54) CABLE WITH MARKED CONDUCTORS FOR IDENTIFICATION AND SORTING

(71) Applicant: Tyco Electronics Corporation, Berwyn, PA (US)

(72) Inventors: Michael David Herring, Apex, NC (US); Philip Gilchrist, Chapel Hill, NC (US)

(73) Assignee: Tyco Electronics Corporation, Berwyn, PA (US)

(21) Appl. No.: 14/179,175

(22) Filed: Feb. 12, 2014

(51) Int. Cl. B25J 9/00; G02B 6/44; H01B 7/36

(52) U.S. Cl. CPC B25J 9/0096; H01B 7/365; G02B 6/4439; Y10S 901/02; Y10S 901/46

(57) ABSTRACT

A cable for use with a conductor sorting system includes multiple conductors and a cable jacket. Each conductor is elongated along a conductor axis between a first end and a second end. Each conductor is marked with a barcode identifier proximate to the first end of the conductor. The barcode identifier is specific to the associated conductor such that the barcode identifier on one conductor differs from the barcode identifier of at least one other conductor. The cable jacket surrounds the multiple conductors along at least part of the length of the conductors.

### BACKGROUND OF THE INVENTION

The subject matter herein relates generally to cables with marked conductors for use in identification and sorting of the conductors.

Many electrical components are mounted to ends of cables. The cables have individual conductors that are terminated to various parts of the electrical component. For example, the conductors may be electrical conductors that are soldered to circuit boards or terminated to contacts of an electrical connector. In another example, the conductors may be optical conductors that are terminated within terminals of an optical connector. Some conductors within the cable may be used to convey different signals than other conductors, such as, for example, power signals, control signals, directional signals, and the like. The conductors are configured to be mated to a specific terminal, contact, or mating conductor that is associated with the signal conveyed by the conductor to allow for proper transmission of the signal. For this reason, the conductors in the cable need to be properly sorted and/or shuffled when mounting the cable to an electrical component to allow the cable to properly transmit signals therethrough.

Typically, the conductors are marked and sorted based on color. Each conductor may have colored coating of a particular color that is used to identify the conductor and provide information associated with the conductor (for example, the type of signal transmitted through the conductor, the circuit that the conductor terminates to, and the like). The colors of the conductors may be visually identified by a camera and/or a human operator. To identify the conductor, the color of the conductor is differentiated from the colors of other conductors in the cable. However, as the number of conductors within cables increase, more colors may be required to mark the conductors for identification purposes, and some of the colors may be similar to other colors. The similarity of the colors and/or poor lighting conditions may cause some identification errors. For example, one conductor may be erroneously identified as another conductor and sorted to mate with the wrong terminal, contact, or mating conductor.

To reduce errors, conductors may be sub-grouped. Grouping conductors within sub-groups reduces the number of colors used. For example, instead of 32 conductors having 32 unique colors, the cable may be sub-grouped into four different colored sub-groups with each sub-group having eight colored conductors. The colors used to identify the conductors may be limited to colors that are not easily mistaken for each other. However, sub-grouping increases the amount of jacketing material used in the cable to partition the groups. The additional jacketing material increases the weight and outer diameter of the cable. In some applications, the number of conductors used in the cable may be limited to a less than desirable amount due to weight or space limitations in the application. The additional jacketing material also increases material and labor costs to group the conductors.

There is a need for a cable having multiple conductors that can be individually identified without relying on color of the conductors.

### BRIEF DESCRIPTION OF THE INVENTION

In an embodiment, a cable for use with a conductor sorting system is provided including multiple conductors and a cable jacket. Each conductor is elongated along a conductor axis between a first end and a second end. Each conductor is marked with a barcode identifier proximate to the first end of the conductor. The barcode identifier is specific to the associated conductor such that the barcode identifier on one conductor differs from the barcode identifier of at least one other conductor. The cable jacket surrounds the multiple conductors along at least part of the length of the conductors.

Optionally, a portion of the conductors that includes the first end and the barcode identifier extends from an end of the cable jacket to allow a sensor of the conductor sorting system to read the barcode identifiers to identify the conductors. Optionally, the barcode identifier includes a sequence of parallel lines and spaces defined therebetween. The position, number, and width of the lines and spaces of the barcode identifier may be specific to the associated conductor. Optionally, the lines of the barcode identifier are oriented orthogonally to the conductor axis. The lines of the barcode identifier may extend at least partially circumferentially around the conductor.

In an embodiment, a conductor sorting system is provided including a cable, a sensor, and a conductor manipulator. The cable has multiple conductors and a cable jacket. The conductors are elongated between first and second ends. The cable jacket surrounds the conductors along at least part of the length of the conductors. Each conductor has an exposed portion that extends from an end of the cable jacket to the first end of the conductor. The exposed portion is marked with a barcode identifier that is specific to the associated conductor. The barcode identifier on one conductor differs from the barcode identifier of at least one other conductor. The cable is positioned such that the exposed portions of the conductors are located in a conductor sorting area. The sensor is positioned to view the conductor sorting area. The sensor is configured to read the barcode identifiers of the multiple conductors to identify each of the conductors based on the barcode identifiers. The conductor manipulator is movable relative to the conductor sorting area. The conductor manipulator is configured to engage the conductors of the cable to move the conductors to predetermined locations based the identification of the conductors.

In an embodiment, a cable for use with a conductor sorting system is provided including multiple conductors and a cable jacket. The multiple conductors are elongated along a conductor axis between a first end and a second end. The cable jacket surrounds the conductors along at least part of the length of the conductors. Each conductor has an exposed portion that extends from an end of the cable jacket to the first end of the conductor. The exposed portion is marked with a barcode identifier that is specific to the associated conductor such that the barcode identifier on one conductor differs from the barcode identifier of at least one other conductor. The barcode identifier for each conductor includes a sequence of parallel lines and spaces defined therebetween. The lines are oriented orthogonally to the conductor axis.

### BRIEF DESCRIPTION OF THE DRAWINGS

FIG. 1 illustrates a conductor sorting system formed in accordance with an exemplary embodiment.

FIG. 2 illustrates a cable and conductors of the cable positioned for termination to a circuit board.

FIG. 3 illustrates the cable and the conductors positioned for termination to an optical connector.

FIG. 4 illustrates the cable formed in accordance with an exemplary embodiment.

FIG. 5 shows the cable according to another embodiment.

### DETAILED DESCRIPTION OF THE INVENTION

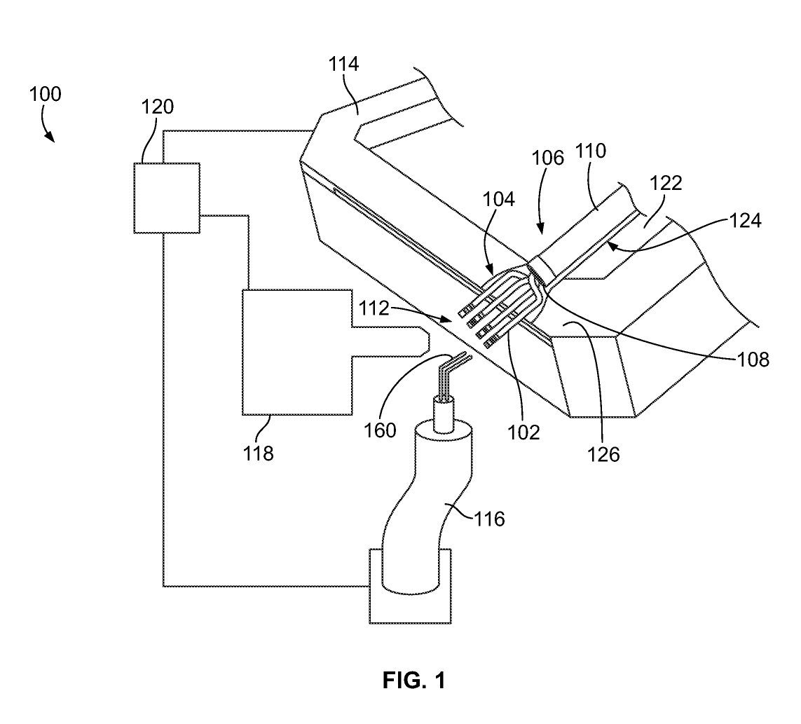

FIG. 1 illustrates a conductor sorting system 100 formed in accordance with an exemplary embodiment. The conductor sorting system 100 is used for identifying individual conductors 102 from a conductor bundle 104 of a cable 106 and positioning the conductors 102 in proper position for processing and/or termination. The conductor sorting system 100 automatically sorts and/or shuffles the conductors 102 using an automated process. Alternatively, components of the conductor sorting system 100 may be used to aid in a manual conductor sorting process, while providing advantages that make the manual conductor sorting process more efficient than conventional processes.

At least a portion of the conductor bundle 104 may extend from a first end 108 of a cable jacket 110 of the cable 106. The conductor bundle 104 is presented at a conductor sorting area 112 of the conductor sorting system 100. The conductors 102 may be individually separated from the other conductors 102 for further processing, such as for stripping, cleaving, and/or terminating the conductors 102 to an electrical component, such as a circuit board or a connector.

The conductor sorting system 100 may include the cable 106, a fixture 114, a conductor manipulator 116 (for example, gripper), a sensor 118, and a controller 120. The fixture 114 holds the cable 106 and the conductor bundle 104 at the conductor sorting area 112. The conductor manipulator 116 grips individual conductors 102 and moves the conductors 102 to a predetermined location. The sensor 118 identifies the particular conductors 102 and may sense the locations of the conductors 102 in the sorting area 112. The information obtained by the sensor 118 may be used to control operation of the conductor manipulator 116. The controller 120 may be coupled to the sensor 118, the conductor manipulator 116, and/or the fixture 114 to control operation thereof and/or to receive feedback therefrom.

The fixture 114 includes a cable support 122 used to hold the cable 106 in place. The cable support 122 may include an elongated channel 124. The cable 106 is set in the channel 124. The cable support 122 optionally may include one or more clamps or fingers to fix the cable 106 in the channel 124 on the cable support 122. Optionally, the cable support 122 may include multiple channels 124, such as for holding multiple cables 106 using the same fixture 114. Optionally, the channels 124 may have different sizes for receiving different size cables 106. The fixture 114 also includes a conductor support 126 used to hold the conductors 102 of the conductor bundle 104 extending from the cable jacket 110. The conductor support 126 optionally includes a plurality of individual cradles that support and/or separate the individual conductors 102. One or more clamps or fingers may be located on the conductor support 126 to fix the conductor bundle 104 in place on the conductor support 126.

The conductor manipulator 116 may include tongs or arms 160 that are used to grasp the individual conductors 102. The manipulator 116 moves the conductors 102 to a predetermined location. The predetermined location may be a specific cradle on the conductor support 126. Alternatively, or in addition, the predetermined location may be a particular terminal or contact in a connector, a pad on a circuit board, a lead on a lead frame, or the like. For example, the conductor manipulator 116 may move each conductor 102 to a predetermined terminal in a connector for coupling to the connector. The operation of the conductor manipulator 116 is controlled by the controller 120. The conductor manipulator 116 may be movable in three dimensions to move the conductor 102 to a desired location. The arms 160 of the manipulator 116 may be configured for translational movement, angular movement, and/or rotational movement. The conductor manipulator 116 may be controlled by a robotic motion system, such as a Cartesian motion robot with a rotary axis, a selective compliance assembly robot arm (SCARA) or other robotic motion system.

The sensor 118 is used to identify and locate the conductors 102. The sensor 118 is positioned proximate to the conductor sorting area 112 to view the conductors 102 of the conductor bundle 104. Optionally, the sensor 118 may be a part of, or coupled to, the conductor manipulator 116. The sensor 118 is used to identify individual conductors 102. For example, the sensor 118 may be configured to read marked identifiers on the conductors 102 to identify and distinguish the conductors 102. Optionally, the sensor 118 may identify other characteristics of the conductors 102 in the conductor bundle 104, such as the shape, layout, positional data, and the like, to allow the conductor manipulator 116 to locate and grip a specific conductor 102 in the conductor bundle 104. The sensor 118 may include a light source and a photodetector to read the marked identifiers. Optionally, the sensor 118 may include a camera to identify other characteristics of the conductors 102, such as the shape, layout, and positional data.

The sensor 118 is coupled to the controller 120 such that data obtained by the sensor 118 is transmitted to the controller 120. The controller 120 processes the data to control operation of other components, such as the conductor manipulator 116. For example, the sensor 118 may determine a position of a particular conductor 102, and the controller 120 may operate the conductor manipulator 116 to grasp the conductor 102 and move the conductor 102 to a particular location. In addition, the sensor 118 may identify the particular conductor 102 based on a marked identifier, and the controller 120 may include a look-up table that associates the conductor 102 with a particular predetermined location. The controller 120 may operate the conductor manipulator 116 to move the conductor 102 to the particular location described in the look-up table. The particular location may be a specific placement relative to the other conductors 102 in the conductor support 126 of the fixture 114, or the particular location may be a specific placement on a component, such as a pad on a circuit board, a lead on a lead frame, a terminal or contact on a connector, and the like. Other conductors 102 may be manipulated in a similar fashion to position each of the conductors 102 in predetermined locations.

In an alternative embodiment, rather than using an automated conductor manipulator 116, the conductors 102 may be sorted manually by hand. The sensor 118 and controller 120 may be used to identify the specific conductors 102 and alert the user (for example, by visual display or by audio) of the predetermined locations of each of the conductors 102. The conductor sorting system 100 may increase productivity by reducing assembly time by notifying the user where each of the conductors 102 should be placed.

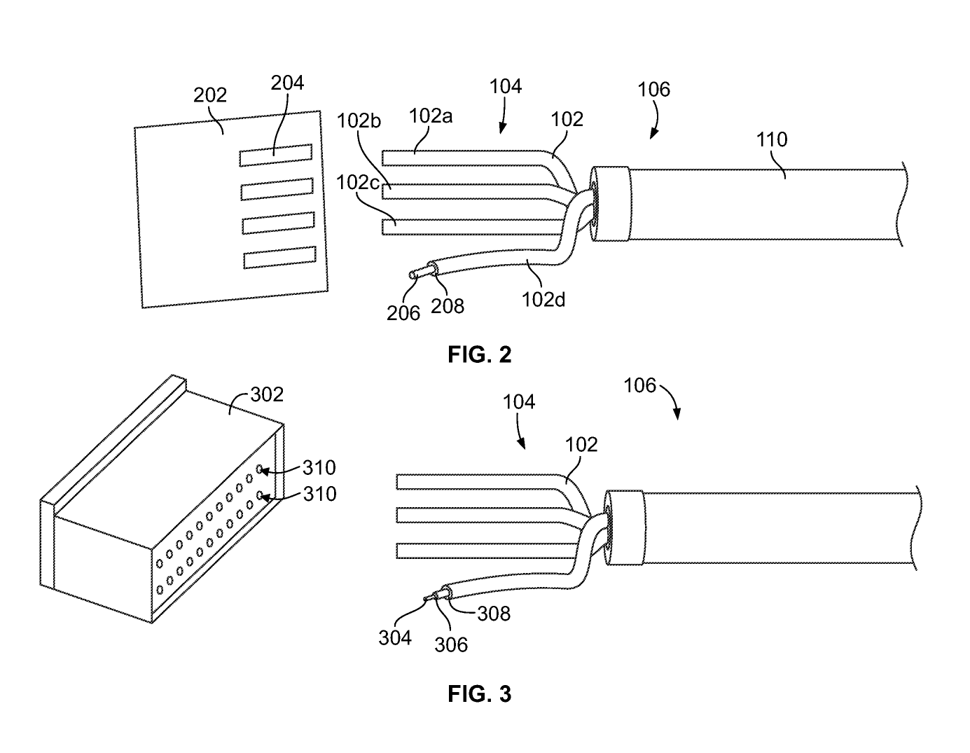

FIG. 2 illustrates the cable 106 and the conductors 102 positioned for termination to a circuit board 202. The conductors 102 may be electrical conductors 102 configured to convey electrical signals. The electrical conductors 102 may include a conductive core 206 that is at least partially surrounded by an insulative conductor jacket 208. The core 206 may be referred to as a wire 206. The wire 206 may be formed of an electrically conductive material, such as copper. The conductor jacket 208 may be formed of an insulative material, such a polymer, rubber, or the like. The wires 206 of the conductors 102 may be used to transmit various electrical signals, such as control signals, ground power signals, active power signals, and the like. The conductors 102 in the conductor bundle 104 may be used to transmit different electrical signals than other conductors 102 in the bundle 104. In addition, the conductors 102 may differ from one another in other characteristics, such as diameters, materials, colors, identifiers, and the like.

In the illustrated embodiment, the cable 106 includes four conductors 102, including a power conductor 102a, two signal conductors 102b, 102c, and a ground conductor 102d. It should be recognized that the four conductors 102a-d of the cable 106 shown in FIG. 2 are merely for illustration, and the cable 106 may have more than four conductors 102. For example, the cable 106 may have 24, 48, 72, or other numbers of conductors 102 in other embodiments. Any number of conductors 102 may be provided depending on the particular cable type and diameter.

The cable jacket 110 may be formed of a protective material, such as plastic, another type of polymer, rubber, and the like. The cable jacket 110 is configured to absorb forces applied to the cable 106 to protect the conductors 102 within the cable jacket 110. The cable jacket 110 may include or surround additional layers of padding to provide additional protection for the conductors 102.

As shown in FIG. 2, the electrical conductors 102 are positioned for termination to pads 204 of the circuit board 202. The conductors 102 may be oriented at predetermined positions relative to each other by the conductor manipulator 116 (shown in FIG. 1) to align with a corresponding pad 204 of the circuit board 202. For example, the conductors 102 may be aligned in a single row and spaced apart from each other for terminating to the pads 204, which are also spaced apart in a single row on the circuit board 202. The conductors 102 may be spaced apart to correspond to the spacing of the pads 204. The wires 206 of the conductors 102 may be soldered to the pads 204 to electrically connect the conductors 102 of the cable 106 to the circuit board 202. In other embodiments, the conductors 102 of the cable 106 may be positioned for termination to an electrical component other than a circuit board, such as to an electrical connector having individual terminals that each receive a conductor 102 therein. The conductor manipulator 116 may control the positioning of the conductors 102 relative to each other depending on the particular application or end use for the cable 106.

FIG. 3 illustrates the cable 106 and the conductors 102 positioned for termination to an optical connector 302. The conductors 102 may be optical conductors 102 (for example, optical fibers) configured to convey optical signals. The optical conductors 102 may include a conductive core 304 that is at least partially surrounded by a cladding layer 306 and a conductor jacket 308, which surrounds the cladding layer 306. The core 304 may be formed of an optically conductive (for example, light transmissive) material, such as glass or acrylic. Light signals may be transmitted through the core 304 through internal reflection. The cladding layer 306 may also be formed of glass or acrylic, although the cladding layer 306 may have a lower refractive index than the core 304 to reflect light rays that impinge upon the boundary between the core 304 and the cladding 306 back into the core 304. The conductor jacket 308 may be formed of a protective material, such a polymer, rubber, or the like.

The optical conductors 102 may be used to transmit various optical (for example, light) signals. The conductors 102 in the conductor bundle 104 may be used to transmit different optical signals than other conductors 102 in the bundle 104. For example, each pixel of a transmitted image may be conveyed as light through a different core 304. In addition, the conductors 102 may be directional such that some conductors 102 are configured to transmit received signals to a connected component, and other conductors 102 are configured to transmit sent signals from the connected component. In addition, the conductors 102 may differ from one another in other characteristics, such as diameters, materials, colors, identifiers, and the like.

In the illustrated embodiment, the cable 106 includes four optical conductors 102. It should be recognized that the four conductors 102 shown in FIG. 3 are merely for illustration, and the cable 106 may have more than four conductors 102. For example, the cable 106 may have 24, 48, 72, or other numbers of optical conductors 102 in other embodiments. Any number of conductors 102 may be provided depending on the particular cable type and diameter.

As shown in FIG. 3, the optical conductors 102 are positioned for termination to terminals 310 of the optical connector 302. The optical connector 302 may be used for splicing together the optical conductors 102 with mating conductors to result in contiguous light transmitting pipes. Alternatively, the optical connector 302 may include an optical to electric engine that converts the optical signals received by the conductors 102 to electrical signals for electrical transmission or vice-versa. Each conductors 102 may be associated with a particular terminal 310. The conductors 102 may be oriented at predetermined positions relative to each other by the conductor manipulator 116 (shown in FIG. 1) to align with the corresponding terminal 310. The conductors 102 may be spaced apart to correspond to the spacing of the terminals 310. Alternatively, the conductor manipulator 116 may move each conductor 102 into the corresponding terminal 310. The optical conductors 102 may be held within the terminals 310 using an adhesive (for example, an epoxy), by an interference fit, or the like.

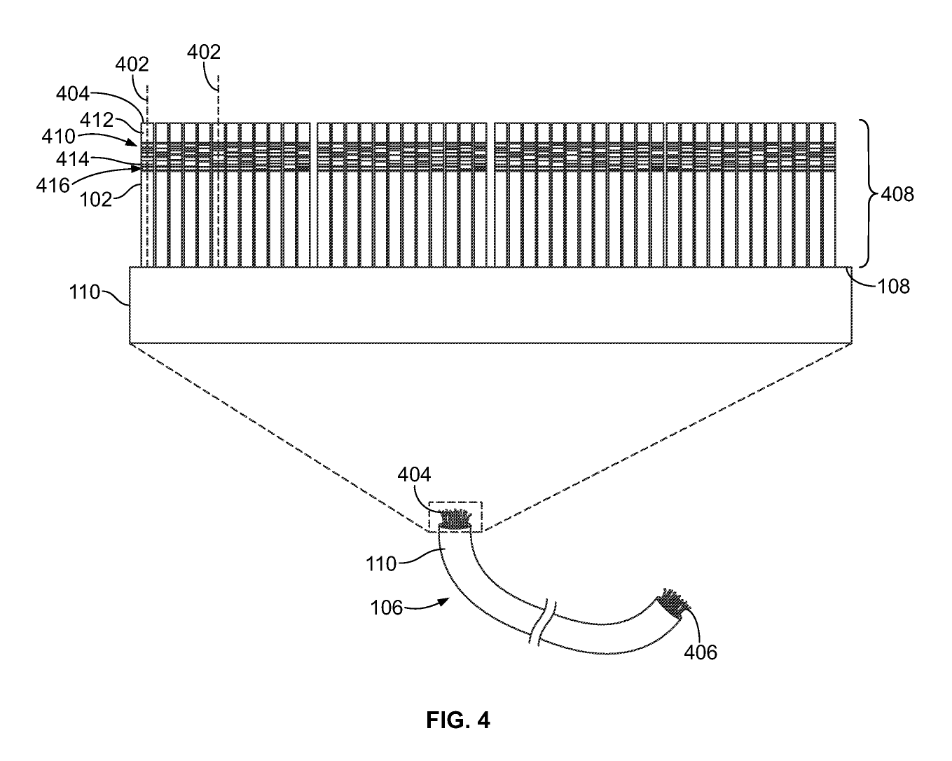

FIG. 4 illustrates the cable 106 formed in accordance with an exemplary embodiment. The cable 106 includes multiple conductors 102 that are each elongated along a respective conductor axis 402 between a first end 404 and an opposite, second end 406. The conductors 102 are held together within the cable jacket 110. The cable jacket 110 surrounds the conductors 102 along at least part of the length of the conductors 102. For example, the cable jacket 110 may surround the conductors 102 for at least most of the length of the conductors 102 except for an exposed portion 408 at one or both ends of the conductors 102, where the conductors 102 extend from an end 108 of the cable jacket 110. The cable jacket 110 generally holds the conductors 102 in parallel such that the conductor axes 402 of the conductors 102 are generally oriented in parallel for the portions of the conductors 102 within the cable jacket 110. Optionally, the conductors 102 may be twisted within the cable jacket 110 while still extending generally parallel between the first end 404 and the second end 406. Although in the enlarged view of FIG. 4 the conductors 102 external to the cable jacket 110 are oriented in parallel, such exposed portions 408 that are not surrounded by the cable jacket 110 may have other, non-parallel, orientations relative to each other.

In an exemplary embodiment, the conductors 102 are each marked with a barcode identifier 410. The barcode identifier 410 is specific to the associated conductor 102 on which the identifier 410 is marked. For example, the barcode identifier 410 on one conductor 102 differs from the barcode identifier 410 of at least one other conductor 102. Optionally, the barcode identifier 410 may be unique and different from the identifiers 410 on all other conductors 102 in the cable 106. The barcode identifier 410 is used for identifying the conductor 102.

The barcode identifiers 410 may be marked on the conductors 102 proximate to the first end 404 of the conductors 102. For example, the barcode identifiers 410 may be marked on the exposed portions 408 of the conductors 102 extending from the cable jacket 110. Each barcode identifier 410 may be marked on a surface 412 of the conductor jacket 208. The marking process may include crimping, stamping, printing, laser marking, or the like.

The barcode identifiers 410 may include a sequence of parallel lines 414 with spaces 416 defined between the lines 414. The position, number, and width (for example, thickness) of the lines 414 and the spaces 416 may be specific to the associated conductor 102. In an embodiment, the lines 414 of the barcode identifier 410 are oriented orthogonally to the conductor axis 402 of the conductor 102. The lines 414 extend at least partially circumferentially around the conductor 102. The conductor 102 may have a cylindrical shape, so the lines 414 may form parallel arcs that extend partially around the conductor 102. Optionally, the lines 414 may extend fully or at least mostly around the circumference or perimeter of the conductor 102 such that the lines 414 form parallel rings. Optionally, the barcode identifiers 410 may be marked in black or a different dark color on light colored conductor jackets 208 (shown in FIG. 2), or vice-versa, in order to clearly show the distinction between lines 414 and spaces 416 to avoid interpretation errors caused by confusing similar colors. The barcode identifier 410 may correspond to a series of numericals, such as numbers and letters. The barcode identifier 410 may correspond to any number of numericals by, for example, increasing or decreasing the number of lines 414.

Referring now also to FIG. 1, the barcode identifier 410 provides information about the associated conductor 102 to the conductor sorting system 100. For example, the exposed portion 408 of the conductors 102 in the cable 106 may be loaded into the conductor sorting area 112. The sensor 118 is configured to view and read the information contained in the barcode identifiers 410. For example, the light source of the sensor 118 may emit light onto the conductors 102 and the photodetector of the sensor 118 may measure the light reflected by the barcode identifiers 410 to read the identifiers 410. By extending the lines 414 at least partially circumferentially around the conductors 102, the sensor 118 may be able to read the barcode identifier 410 to identify the conductor 102 from various radial orientations of the conductors 102 relative to the sensor 118. For example, lines 414 that extend circumferentially around at least most of the circumference of a conductor 102 may allow the sensor 118 to read the barcode identifier 410 regardless of the radial orientation of the conductor 102 relative to the sensor 118.

In an embodiment, the sensor 118 reads the barcode identifiers 410 on the conductors 102 and transmits the information to the controller 120. The sensor 118 may also capture positional information about the conductors 102 using the camera, and send such positional information to the controller 120 as well. The controller 120 may be configured to interpret the received barcode information to identify each of the conductors 102 as well as other information about the conductors. For example, the information in each barcode identifier 410 may also be used to identify a predetermined location to which the conductor 102 should be moved for connection to a component, a type of signal transmitted by the conductor 102, a source of the signal transmitted by the conductor 102, and the like. The controller 120 may interpret the barcode information by referring to a look-up table which associates the barcode identifier 410 and/or the numericals coded in the identifier 410 to the information about the identity of the conductor 102 and the characteristics of the conductor 102.

Based on the information associated with the barcode identifiers 410 of the conductors 102, the controller 120 may operate the conductor manipulator 116 to engage and move the conductors 102 to predetermined locations. The controller 120 may also use the positional information received from the sensor 118 to control the movements of the manipulator 116 to engage the desired conductor 102 of the conductor bundle 104. The predetermined location may include a specific terminal, contact, pad, or lead of a component to which the cable 106 terminates. For example, the barcode identifier 410 on one conductor 102 may associate that conductor 102 to a specific terminal in an optical and/or electrical connector. The conductor manipulator 116 may move that conductor 102 to a predetermined location aligned with, proximate to, or within the terminal for connection of the conductor 102 to the connector.

With further reference to FIG. 4, since the barcode identifiers 410 may be designed to contain varying amounts of information, many different barcode identifiers 410 may be formed. For example, even for an optical cable 106 that includes 72 or more fiber optic conductors 102, each conductor 102 may be marked with a unique barcode identifier 410, if so desired, to identify the conductor 102. Thus, the use of barcode identifiers 410 avoids the problems associated with identifying wires, fibers, and other conductors based on color, which is much more limited. For example, if 72 or more different colors were used to mark the fiber optic conductors 102 in the above example instead of barcode identifiers 410, in an automated sorting system some of the conductors may be confused for other conductors that have a similar color. To reduce such errors based on similar colors, sub-grouping using sub jackets is typically used to reduce the number of different colors. But, sub-jacketing adds material to the cable, which increases weight and diameter. As shown in FIG. 4, no sub-jacketing is required when using barcode identifiers 410 to mark the conductors 102. In addition, the use of a dark color (for example, black) for the lines 414 and a light color (for example, white) for the spaces 416, or vice-versa, reduces the possibility of errors based on confusing colors.

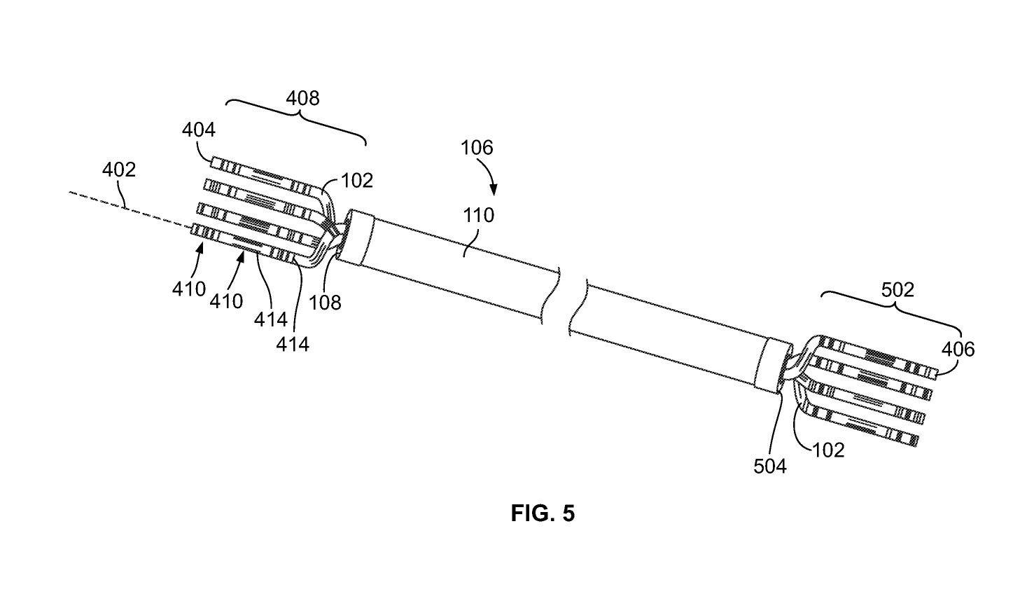

FIG. 5 shows the cable 106 according to another embodiment. In addition to the exposed portion 408 of the conductors 102 that includes the first end 404 of the conductors 102 and extends from the first end 108 of the cable jacket 110, the cable 106 may also include a second exposed portion 502 that includes the second end 406 of the conductors 102 and extends from an opposite second end 504 of the cable jacket 110. Either or both exposed portions 408, 502 may be presented to the conductor sorting area 112 (shown in FIG. 1) of the conductor sorting system 100 (shown in FIG. 1) for sorting and/or connection to a mating component.

Optionally, the barcode identifier 410 may be marked on the associated conductor 102 at multiple axial locations along a length of the conductor 102. For example, the barcode identifier 410 may be marked at multiple axial locations proximate to the first end 404 and at multiple axial locations proximate to the second end 406. Optionally, the barcode identifier 410 may be marked at spaced apart axial locations along the entire length of the conductor 102. Therefore, if the conductor 102 is cleaved to shorten the conductor 102, the barcode identifier 410 may be visible when the cable jacket 110 is removed to form a new exposed portion of the conductor 102.

Optionally, the barcode identifier 410 may have lines 414 that extend parallel to the conductor axis 402. For example, as shown in FIG. 5, the barcode identifier 410 may be marked at various axial locations, with some markings having the lines 414 of the barcode identifier 410 orthogonal to the axis 402 and other markings having the lines 414 parallel to the axis 402. Therefore, the sensor 118 (shown in FIG. 1) may be able to read at least one marking of the barcode identifier 410 in the exposed portions 408, 502 regardless of orientation of the conductor 102 relative to the sensor 118. Optionally, the lines 414 of the barcode identifier 410 may be marked at other orientations relative to the conductor axis 402.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f) or (pre-AIA) 35 U.S.C. §112, sixth paragraph, unless and until such claim limitations expressly use the phrase “means for” followed by a statement of function void of further structure.

What is claimed is:

1. A cable for use with a conductor sorting system comprising:
multiple conductors, each conductor elongated along a conductor axis between a first end and a second end, each conductor marked with a barcode identifier proximate to the first end of the conductor, the barcode identifier specific to the associated conductor such that the barcode identifier on one conductor differs from the barcode identifier of at least one other conductor, and
a cable jacket surrounding the multiple conductors along at least part of the length of the conductors.

2. The cable of claim 1, wherein a portion of the conductors that includes the first end and the barcode identifier extends from an end of the cable jacket to allow a sensor of the conductor sorting system to read the barcode identifiers to identify the conductors.

3. The cable of claim 1, wherein each of the multiple conductors includes at least one of a wire for transmitting electrical signals therethrough or an optical core for transmitting optical signals therethrough.

4. The cable of claim 1, wherein the barcode identifier includes a sequence of parallel lines and spaces defined therebetween, the position, number, and width of the lines and spaces being specific to the associated conductor.

5. The cable of claim 4, wherein the lines of the barcode identifier are oriented orthogonally to the conductor axis.

6. The cable of claim 4, wherein the lines of the barcode identifier extend at least partially circumferentially around the conductor.

7. The cable of claim 1, wherein the barcode identifier is marked on the conductor at multiple axial locations along a length of the conductor.

8. The cable of claim 1, wherein the barcode identifier on each conductor is associated with a predetermined location where the conductor is configured to be connected, the predetermined location including at least one of a terminal, a contact, a pad, or a lead of a component to which the cable is configured to be terminated.

9. The cable of claim 1, wherein each conductor includes a core and a conductor jacket, the core configured to transmit therein at least one of electrical signals or optical signals, the barcode identifier being marked on the conductor jacket.

10. A conductor sorting system comprising:
a cable having multiple conductors and a cable jacket, the conductors elongated between first and second ends, the cable jacket surrounding the conductors along at least part of the length of the conductors, each conductor having an exposed portion that extends from an end of the cable jacket to the first end of the conductor, the exposed portion marked with a barcode identifier that is specific to the associated conductor, the barcode identifier on one conductor differs from the barcode identifier of at least one other conductor; the cable positioned such that the exposed portions of the conductors are located in a conductor sorting area;
a sensor viewing the conductor sorting area, the sensor configured to read the barcode identifiers of the multiple conductors to identify each of the conductors based on the barcode identifiers; and
a conductor manipulator movable relative to the conductor sorting area, the conductor manipulator being configured to engage the conductors of the cable to move the conductors to predetermined locations based the identification of the conductors.

11. The system of claim 10, wherein the barcode identifier includes a sequence of parallel lines and spaces defined therebetween, the position, number, and width of the lines and spaces being specific to the associated conductor.

12. The system of claim 11, wherein the lines of the barcode identifier are oriented orthogonally to a conductor axis of the conductor.

13. The system of claim 11, wherein the lines of the barcode identifier extend at least partially circumferentially around the conductor.

14. The system of claim 10, wherein the barcode identifier is marked on the conductor at multiple axial locations along a length of the conductor.

15. The system of claim 10, wherein each conductor includes a core and a conductor jacket, the core configured to transmit therein at least one of electrical signals or optical signals, the barcode identifier being marked on the conductor jacket.

16. The system of claim 10, further comprising a controller communicatively coupled to the scanner and the conductor manipulator, the controller receiving barcode identifier information from the sensor and operating the conductor manipulator to engage and move the conductors to the predetermined locations based on the received barcode identifier information.

17. The system of claim 10, wherein the barcode identifier on each conductor is associated with a specific terminal in a connector, the conductor manipulator moving each conductor to the predetermined location for connection of the conductor within the specific terminal in the connector.

18. The system of claim 10, wherein the sensor includes a light source that emits light within the conductor sorting area and a photodetector that measures the light reflected by the barcode identifiers of the conductors.

19. A cable for use with a conductor sorting system comprising:
multiple conductors elongated along a conductor axis between a first end and a second end; and
a cable jacket surrounding the conductors along at least part of the length of the conductors;
wherein each conductor has an exposed portion that extends from an end of the cable jacket to the first end of the conductor, the exposed portion marked with a barcode identifier that is specific to the associated conductor such that the barcode identifier on one conductor differs from the barcode identifier of at least one other conductor,
wherein the barcode identifier for each conductor includes a sequence of parallel lines and spaces defined therebetween, the lines oriented orthogonally to the conductor axis.

20. The cable of claim 19, wherein the lines of the barcode identifier extend circumferentially around at least most of the circumference of the conductor to allow a sensor of the conductor sorting system to read the barcode identifier to identify the conductor regardless of the radial orientation of the conductor relative to the sensor.
